(19) United States
(12) Patent Application Publication
(10) Pub. No.: US 2026/0107049 A1
(43) Pub. Date: Apr. 16, 2026

(54) LEARNED MODEL AND INFORMATION PROCESSING APPARATUS

(71) Applicant: OLYMPUS MEDICAL SYSTEMS CORP., Tokyo (JP)

(72) Inventors: Yuto SHINDO, Tokyo (JP); Tetsuhiro OKA, Tokyo (JP); Yuki NAMII, Tokyo (JP)

(73) Assignee: OLYMPUS MEDICAL SYSTEMS CORP., Tokyo (JP)

(21) Appl. No.: 19/353,075

(22) Filed: Oct. 8, 2025

(30) Foreign Application Priority Data
Oct. 10, 2024 (JP) 2024-178343

(51) Int. Cl. H04N 23/50; G06T 5/70

(52) U.S. Cl. CPC H04N 23/555; G06T 5/70

(57) ABSTRACT

A learned model is caused to learn by machine learning by using: a correct answer image obtained by performing first reduction processing for image reduction on an original image obtained by photographing a predetermined object to be photographed by a first image pickup system; and a training image obtained by performing second reduction processing for image reduction on the original image and performing, on an image as a result of the second reduction processing, blur addition processing for correcting a contrast difference due to a difference in a number of pixels between the image as the result of the second reduction processing and a processing target image photographed by a second image pickup system.

### CROSS REFERENCE TO RELATED APPLICATIONS

This application claims the benefit of Japanese Application No. 2024-178343 filed in Japan on October 10, 2024, the contents of which are incorporate by this reference.

### BACKGROUND OF THE INVENTION

### 1. Field of the Invention

The present disclosure relates to a learned model and an information processing apparatus.

### 2. Description of the Related Art

There are increasing demands for developments of thin-diameter endoscopes that cause less pain for a patient, single-use endoscopes for preventing infectious diseases, and the like. On the other hand, deterioration of an image quality due to an excessive reduction in diameters of endoscopes and a use of mass-produced imagers will be main causes of overlooking of a lesion and stresses on doctors. In view of such circumstances, there is a strong demand for a technology to improve an image quality while using a thin-diameter endoscope and a mass-produced imager.

As one method for realizing an improvement of an image quality, deep learning is known. In such deep learning, a learned model is generated by causing an AI to learn learning data including a pair of a correct answer image and a training image. The correct answer image is a high-resolution image picked up by a high-resolution photographing device (high-end device). The training image is a low-resolution image, an image quality of which has been lowered by adding a blur and the like to the correct answer image. The learned model thus generated is used to perform inference for converting a low-resolution image, which is a processing target image into a high-resolution image, thereby realizing a generation of an image with very high image quality.

Japanese Patent Application Laid-Open Publication No. 2022-70035, for example, discloses a method for creating a machine learning model with enhanced robustness against noises, by creating data for learning by using an image obtained by performing noise reduction on an input image for medical use as a correct answer image, and using an image obtained by reducing the correct answer image to a low-resolution image as a training image.

### SUMMARY OF THE INVENTION

A learned model according to one aspect of the present disclosure is caused to learn by machine learning by using: a correct answer image obtained by performing first reduction processing for image reduction on an original image obtained by photographing a predetermined object to be photographed by a first image pickup system; and a training image obtained by performing second reduction processing for image reduction on the original image and performing, on an image as a result of the second reduction processing, blur addition processing for correcting a contrast difference due to a difference in a number of pixels between the image as the result of the second reduction processing and a processing target image photographed by a second image pickup system.

A learned model according to another aspect of the present disclosure is caused to learn by machine learning by using: a first correct answer image obtained by performing first reduction processing for image reduction on a first original image obtained by photographing a predetermined object to be photographed by a first image pickup system; a first training image obtained by performing second reduction processing for image reduction on the first original image or on a first intermediate image obtained by performing image pickup system simulating processing on the first original image and performing, on an image as a result of the second reduction processing, blur addition processing for correcting a contrast difference due to a difference in a number of pixels between the image as the result of the second reduction processing and a processing target image photographed by a third image pickup system; a first learning set including a pair of the first correct answer image and the first training image; a second correct answer image obtained by performing third reduction processing for image reduction on a second original image obtained by photographing the predetermined object to be photographed by a second image pickup system; a second training image obtained by performing fourth reduction processing for image reduction on the second original image or on a second intermediate image obtained by performing the image pickup system simulating processing on the second original image and performing, on an image as a result of the fourth reduction processing, blur addition processing for correcting a contrast difference due to a difference in a number of pixels between the image as the result of the fourth reduction processing and the processing target image photographed by the third image pickup system; a second learning set including a pair of the second correct answer image and the second training image; and a plurality of learning sets including the first learning set and the second learning set.

A learned model according to another aspect of the present disclosure is caused to learn by machine learning by using: a correct answer image obtained by performing first reduction processing for image reduction on an original image obtained by photographing by a first image pickup system and performing, on an image as a result of the first reduction processing, second reduction processing for generating an image having an aspect ratio different from an aspect ratio of the image as the result of the first reduction processing; and a training image obtained by performing third reduction processing for image reduction on the original image, performing, on an image as a result of the third reduction processing, blur addition processing for correcting a contrast difference due to a difference in a number of pixels between the image as the result of the third reduction processing and a processing target image photographed by a second image pickup system, and performing, on an image as a result of the blur addition processing, fourth reduction processing for generating an image having an aspect ratio different from an aspect ratio of the image as the result of the blur addition processing.

An information processing apparatus according to another aspect of the present disclosure includes: a correct answer image generation unit configured to generate a correct answer image by performing first reduction processing for image reduction on an original image obtained by photographing a predetermined object to be photographed by a first image pickup system; and a training image generation unit configured to generate a training image by performing second reduction processing for image reduction on the original image and performing, on an image as a result of the second reduction processing, blur addition processing for correcting a contrast difference due to a difference in a number of pixels between the image as the result of the second reduction processing and a processing target image photographed by a second image pickup system.

### BRIEF DESCRIPTION OF THE DRAWINGS

FIG. 1 shows one example of processing flows of model creation processing and learned model inference processing according to a first embodiment.

FIG. 2 shows one example of a relationship between an original image and a correct answer image in the processing flow of the model creation processing in the first embodiment.

FIG. 3 shows one example of a relationship between the original image and a training image in the processing flow of the model creation processing in the first embodiment.

FIG. 4 shows one example of processing flows of model creation processing and learned model inference processing according to a second embodiment.

FIG. 5 shows one example of a relationship between an original image and a correct answer image in the processing flow of the model creation processing in the second embodiment.

FIG. 6 shows one example of a relationship between the original image and a training image in the processing flow of the model creation processing in the second embodiment.

FIG. 7 shows one example of processing flows of model creation processing and learned model inference processing according to a third embodiment.

FIG. 8 shows one example of a relationship between an original image and a correct answer image in the processing flow of the model creation processing in the third embodiment.

FIG. 9 shows one example of a relationship between the original image and a training image in the processing flow of the model creation processing in the third embodiment.

FIG. 10 shows one example of processing flows of model creation processing and learned model inference processing according to a fourth embodiment.

FIG. 11 shows one example of a relationship between original images and correct answer images in the processing flow of the model creation processing in the fourth embodiment.

FIG. 12 shows one example of a relationship between the original images and training images in the processing flow of the model creation processing in the fourth embodiment.

FIG. 13 shows one example of processing flows of model creation processing and learned model inference processing according to a fifth embodiment.

FIG. 14 is a block diagram of a machine learning apparatus 1 which is an information processing apparatus according to a sixth embodiment.

FIG. 15 is a block diagram of a configuration in which a learned model caused to learn using a machine learning apparatus which is an information processing apparatus according to a seventh embodiment is applied to an endoscope system.

### DETAILED DESCRIPTION OF THE PREFERRED EMBODIMENT(S)

Hereinafter, embodiments of the present disclosure will be described with reference to drawings.

### First Embodiment

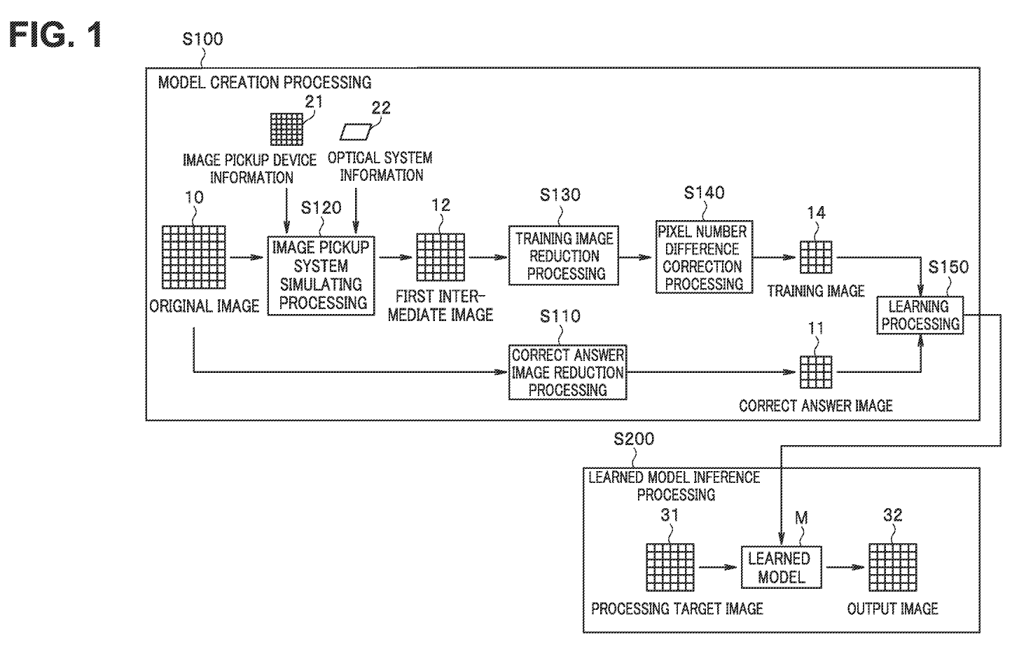

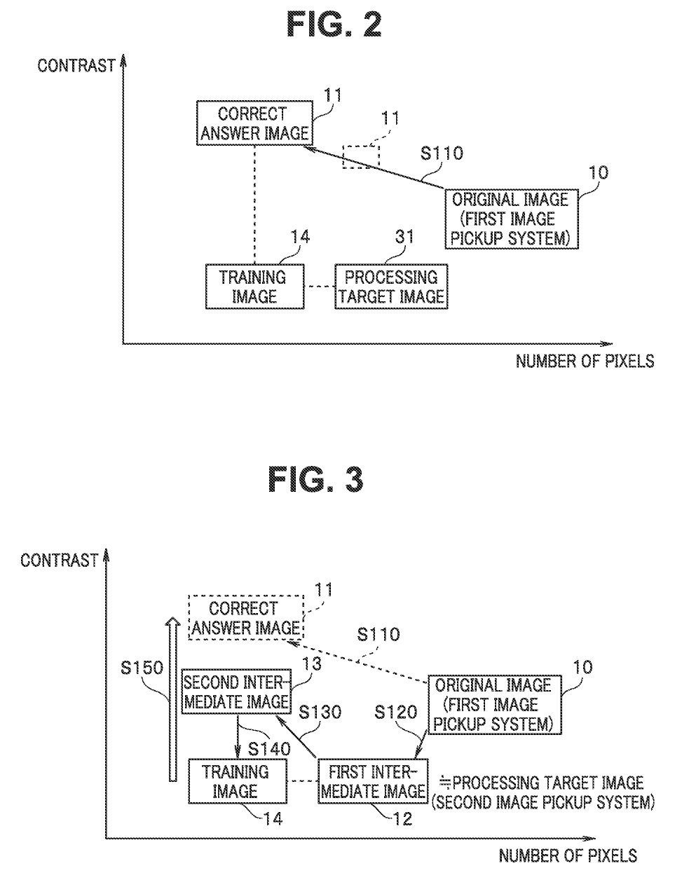

FIG. 1 shows one example of processing flows of model creation processing and learned model inference processing according to a first embodiment. FIG. 2 shows one example of a relationship between an original image and a correct answer image in the processing flow of the model creation processing in the first embodiment. FIG. 3 shows one example of a relationship between the original image and a training image in the processing flow of the model creation processing in the first embodiment.

As shown in FIG. 1, in model creation processing S100, a correct answer image 11 and a training image 14 are generated from an inputted original image 10. Then, in the model creation processing S100, learning processing S150 is performed using the correct answer image 11 and the training image 14, and a learned model M is generated. The original image 10 is an image picked up by a first image pickup system with a high resolution. Note that the detailed processing flow of the model creation processing S100 will be described later.

In learned model inference processing S200, inference processing is performed on an inputted processing target image 31 by using the learned model M generated in the model creation processing S100, and an output image 32 is outputted. The processing target image 31 is an image picked up by a second image pickup system having a resolution lower than the first image pickup system.

Hardware configured to perform the learned model inference processing S200 is a general purpose processor including a CPU, and the like, for example. In this case, a program in which an inference algorithm is described, and parameters used in the inference algorithm are stored, as the learned model M, in a storage section, for example. Alternatively, the learned model inference processing S200 may be performed by a dedicated processor configured by implementing the inference algorithm as hardware. The dedicated processor includes, for example, an ASIC (Application Specific Integrated Circuit), an FPGA (Field Programmable Gate Array), or the like. In this case, the parameters used in the inference algorithm are stored, as the learned model M, in the storage section, for example.

A neural network can be applied to the inference algorithm. Weighting factors assigned to the respective inter-node connections in the neural network are the parameters. The neural network includes an input layer which receives image data, an intermediate layer which performs arithmetic processing on the inputted data through the input layer, and an output layer which outputs the image data based on the arithmetic result outputted from the intermediate layer. As a neural network to be used for the inference processing, a CNN (Convolutional Neural Network) may be used. However, the neural network is not limited to the CNN, and various AI (Artificial Intelligence) technologies can be employed.

In order to achieve these technologies, conventional general-purpose arithmetic processing circuits such as a CPU, an FPGA, and the like can be used. However, in view of the fact that a large part of the processing performed by the neural network is matrix multiplication, processing units called a GPU and a TPU (Tensor Processing Unit), which are specialized for the matrix calculation, are used in some cases. In recent years, such “neural network processing unit (NPU)” which is hardware dedicated for artificial intelligence (AI), is designed to be able to be integrated and incorporated with other circuits such as a CPU, and the NPU is a part of the processing circuit in some cases.

In the model creation processing S100, the original image 10 picked up by the first image pickup system is inputted. The original image 10 is an image having a resolution higher than that of the processing target image 31 picked up by the second image pickup system. In addition, the original image 10 is a source image from which the correct answer image 11 and the training image 14 that are used in the learning processing S150 are generated.

In correct answer image reduction processing S110 (first reduction processing), processing for reducing the original image 10 is performed, to generate the correct answer image 11. The processing for reducing the original image 10 is processing for interpolating pixels or processing for thinning out pixels, for example. Such image reduction enables a structure such as blood vessels expressed, for example, by ten pixels to be expressed by five pixels, with the contrast being substantially maintained. In other words, the number of pixels for expressing the structure decreases, with the contrast being substantially maintained.

Thus, with the correct answer image reduction processing S110, a spatial frequency characteristic per pixel is converted into a spatial frequency characteristic on the high-frequency side, and thereby the correct answer image 11 having a higher contrast than that of the original image 10 is generated. As a result, as shown in FIG. 2, with the correct answer image reduction processing S110, the correct answer image 11 having a smaller number of pixels and the higher contrast than those of the original image 10 is generated.

Note that the number of pixels of the correct answer image 11 is equal to the number of pixels of the training image 14 to be described later, but not limited thereto. The number of pixels of the correct answer image 11 may be smaller than the number of pixels of the original image 10.

In image pickup system simulating processing S120, image pickup device information 21 and optical system information 22 are inputted. The image pickup device information 21 includes information on an image pickup device of the first image pickup system, and information on an image pickup device of the second image pickup system. Furthermore, the optical system information 22 includes information on an optical system of the first image pickup system, and information on an optical system of the second image pickup system.

In the image pickup system simulating processing S120, the image pickup device information 21 and the optical system information 22 are used to perform processing for reducing an image and degrading the frequency characteristics thereof such that the characteristics of the original image 10 picked up by the first image pickup system become substantially the same as the characteristics of the processing target image 31 picked up by the second image pickup system, and a first intermediate image 12 is generated. With such processing, as shown in FIG. 3, the first intermediate image 12 having a smaller number of pixels and a lower contrast than those of the original image 10, is generated. The characteristics of the first intermediate image 12 are substantially the same as those of the processing target image 31 picked up by the second image pickup system.

In other words, in the image pickup system simulating processing S120, processing for converting the original image 10 picked up by the first image pickup system into an image which is like the one picked up by the second image pickup system is performed. Specifically, based on optical characteristic information and noise characteristic information of the first image pickup system and optical characteristic information and noise characteristic information of the second image pickup system, a correction filter corresponding to a difference between the optical characteristic of the first image pickup system and that of the second image pickup system and a correction noise corresponding to a difference between the noise characteristic of the first image pickup system and that of the second image pickup system are calculated and added to the original image 10. In addition, the reduction processing is performed on the original image such that the number of the pixels of the original image becomes substantially equal to that of the image photographed by the second image pickup system.

The noise characteristic information indicates a random noise, for example, and is information how much noise is to be added to which position. The noise characteristic information may include both the information on the noise position and information on the amount of noise, but may include only either of these. When noise standard deviation information is used as the noise characteristic information, the amount of noise may be uniform or variable relative to a pixel value.

In a case where an image pickup method differs in the first image pickup system and the second image pickup system, processing for simulating the image pickup method is performed. As the image pickup method, a sequential image pickup method and a simultaneous image pickup method are known. In the sequential image pickup method, a plurality of colors of illumination light are applied sequentially, and image pickup is performed by a monochrome image pickup device at a timing at which each of the plurality of colors of light is applied. In the simultaneous image pickup method, white light is applied, and the image pickup device includes a plurality of pixels, each of which receives a different color of light.

For example, when the first image pickup system employs the sequential image pickup method and the second image pickup system employs the simultaneous image pickup method, the image pickup method of the second image pickup system is simulated by generating signals of the respective pixels of the simultaneous type image pickup device, based on a signal generated by at least one color of light of the signals generated by a plurality of colors of light acquired by the pixels of the monochrome image pickup device of the first image pickup system.

With the processing for simulating the image pickup method, the characteristics of the first intermediate image 12 is made to be substantially the same as the characteristics of the processing target image 31.

In training image reduction processing S130 (second reduction processing), processing for reducing the first intermediate image 12 is performed to generate a second intermediate image 13 (see FIG. 3). The processing for reducing the first intermediate image 12 is processing for interpolating the pixels or thinning out the pixels, for example. With the training image reduction processing S130, the spatial frequency per pixel is converted into the one on the high-frequency side. As a result, as shown in FIG. 3, the second intermediate image 13 having a smaller number of pixels than that of the first intermediate image 12 and a higher contrast than that of the first intermediate image 12 is generated.

In pixel number difference correction processing S140, correction processing is performed such that the second intermediate image 13 having the higher contrast than that of the first intermediate image 12, which has been generated in the training image reduction processing S130, has a contrast of the same level as that of the image picked up by the second image pickup system, and thereby a training image 14 is generated.

Specifically, in the pixel number difference correction processing S140, blur addition processing for adding a blur for correcting a contrast difference due to a difference in the number of pixels between the training image 14 and the processing target image 31. In other words, in the pixel number difference correction processing S140, the correction filter is applied, and processing for degrading the frequency characteristics, which have been increased by the training image reduction processing S130, to those corresponding to the frequency characteristics of the processing target image 31 (or those corresponding to the frequency characteristics of the first intermediate image 12). As a result, as shown in FIG. 3, the training image 14 having a smaller number of pixels than that of the processing target image 31 (the first intermediate image 12) and a contrast of the same level as that of the processing target image 31 (first intermediate image 12) is generated.

Note that, as the correction filter, for example, a Gaussian filter or the like can be used, but not limited thereto. Any given filter can be used, as long as the filter is capable of performing the blur addition processing. In addition, the blur addition processing may be performed using data of PSF (point spread function) acquired from the optical system data.

Noise may be re-added for correcting the amount of noise decreased by the pixel number difference correction processing.

The image pickup system simulating processing, the reduction processing, the pixel number difference correction processing, and the noise re-addition processing may be performed independently in this order, but the order of performing each processing may be changed, and a plurality of processing may be performed simultaneously.

In learning processing S150, machine learning is performed by using the high-contrast correct answer image 11 generated by the correct answer image reduction processing S110 and the low-contrast training image 14 generated by the image pickup system simulating processing S120, the training image reduction processing S130, and the pixel number difference correction processing S140, and the learned model M is outputted. A pair of the correct answer image 11 and the training image 14 is data set for learning, which is to be used in the machine learning, and is also called as teacher data.

Thus, in the present embodiment, the correct answer image reduction processing S110 is performed on the original image 10 photographed by the first image pickup system (high resolution), and the correct answer image 11 having the higher contrast than that of the original image 10 is generated. Furthermore, the image pickup system simulating processing S120 is performed, to generate the image (first intermediate image 12) corresponding to the processing target image 31 from the original image 10, and then, the training image reduction processing S130 and the pixel number difference correction processing S140 are performed on the first intermediate image 12, to generate the training image 14. Then, at the time of learning, the learning processing S150 is performed by using the pair of the correct answer image 11 and the training image 14, to generate the learned model M.

When inference is performed, in the learned model inference processing S200, the image photographed by the second image pickup system (low resolution) is inputted as the processing target image 31, inference is performed using the learned model M, and an output image (inference image) 32 having a higher contrast and a higher resolution than those of the original image 10 photographed by the first image pickup system (high resolution) is outputted.

As a result, the learned model M of the present embodiment is capable of outputting the output image having the higher contrast than that of the high-resolution image photographed by the high-resolution photographing device.

### Second Embodiment

A second embodiment will now be described.

In general, it is impossible to cause an AI to learn without a teacher image having a higher contrast than that of an image photographed by a high-resolution photographing device. Therefore, when an image having a further higher contrast than that of an image photographed by the high-resolution photographing device is required, a correct answer image having a higher contrast than that of the image photographed by the high-resolution photographing device is required to be generated, to thereby cause the AI to learn. In the second embodiment, description will be made on an example in which machine learning is performed using the own image photographed by a photographing device such as the high-resolution photographing device as an original image of the correct answer image and a training image.

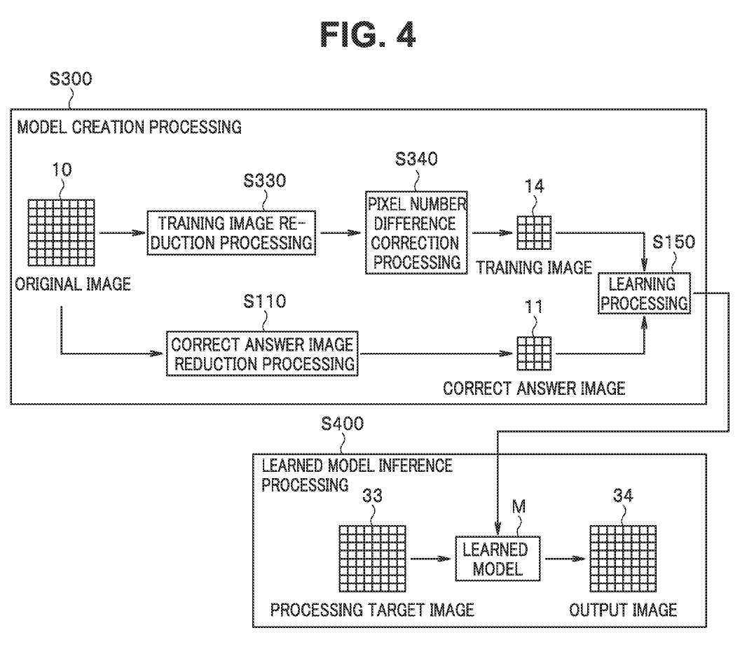

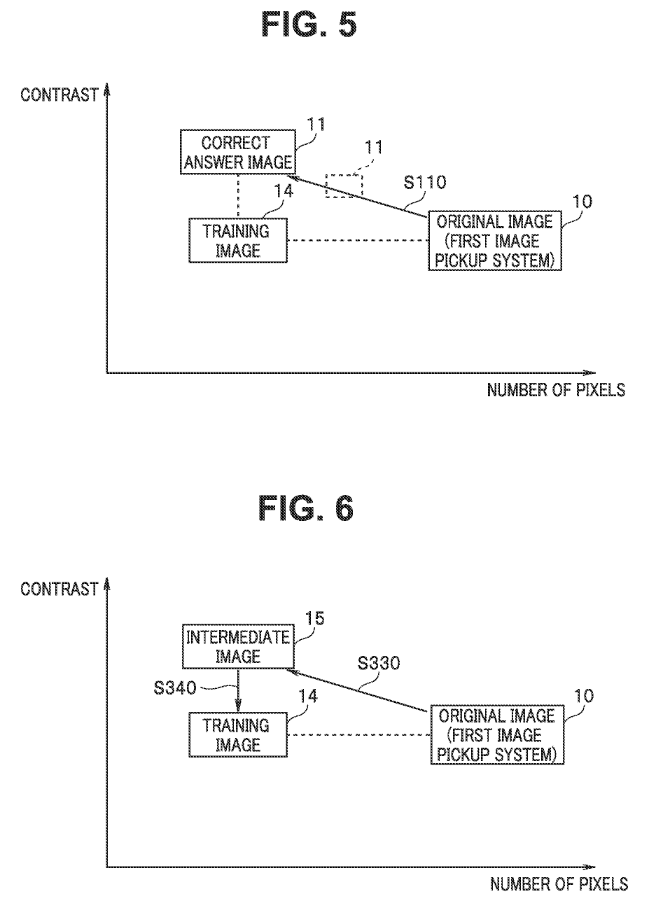

FIG. 4 shows one example of processing flows of model creation processing and learned model inference processing according to the second embodiment. FIG. 5 shows one example of a relationship between the original image and the correct answer image in the processing flow of the model creation processing in the second embodiment. FIG. 6 shows one example of a relationship between the original image and the training image in the processing flow of the model creation processing in the second embodiment. Note that, in FIGS. 4, 5, and 6, the same constituent elements as those in FIGS. 1, 2, and 3 are attached with the same reference signs and descriptions thereof will be omitted.

In model creation processing S300, an original image 10 photographed by a first image pickup system is inputted. In learned model inference processing S400, a processing target image 33 photographed by the first image pickup system is inputted. In other words, in the present embodiment, the original image 10 and the processing target image 33 are images picked up by the same image pickup system (first image pickup system).

In correct answer image reduction processing S110, processing for reducing the original image 10 is performed and a correct answer image 11 is generated. With the correct answer image reduction processing S110, a spatial frequency per pixel is converted into the one on the high-frequency side, and the correct answer image 11 having a higher contrast than that of the original image 10 is generated. In other words, as shown in FIG. 5, with the correct answer image reduction processing S110, the correct answer image 11 having a smaller number of pixels and the higher contrast than those of the original image 10 is generated. Note that the number of pixels of the correct answer image 11 has only to be smaller than the number of pixels of the original image 10.

In training image reduction processing S330, processing for reducing the original image 10 is reduced, and an intermediate image 15 (see FIG. 6) is generated. With the training image reduction processing S330, the spatial frequency per pixel is converted into the one on the high-frequency side, and thereby an intermediate image 15 having a smaller number of pixels and a higher contrast than those of the original image 10 is generated.

As described above, the original image 10 and the processing target image 33 are the images picked up by the same first image pickup system, and have substantially the same characteristics. Therefore, the intermediate image 15 generated by the training image reduction processing S330 is an image having a smaller number of pixels than that of the processing target image 33 and a higher contrast than that of the processing target image 33.

In pixel number difference correction processing S340, correction processing is performed such that the contrast of the intermediate image 15, which has been increased higher than that of processing target image 33 by the training image reduction processing S330, becomes a contrast of the same level as that of the processing target image 33, and thereby a training image 14 is generated.

Specifically, in the pixel number difference correction processing S340, blur addition processing for adding a blur for correcting a contrast difference due to a difference in the number of pixels between the training image 14 and the processing target image 33. In other words, in the pixel number difference correction processing S340, the correction filter is applied, and processing for degrading the frequency characteristics, which have been increased by the training image reduction processing S330, to those corresponding to the frequency characteristics of the processing target image 33. As a result, as shown in FIG. 6, the training image 14 having the smaller number of pixels than that of the processing target image 33 and a contrast of the same level as that of the processing target image 33 is generated.

Noise may be re-added for correcting the amount of noise decreased by the pixel number difference correction processing.

The reduction processing, the pixel number difference correction processing, and the noise re-addition processing may be performed independently in this order, but the order of performing each processing may be changed, and a plurality of processing may be performed simultaneously.

In learning processing S150, machine learning is performed by using the high-contrast correct answer image 11 generated by the correct answer image reduction processing S110 and the low-contrast training image 14 generated by the training image reduction processing S330 and the pixel number difference correction processing S340, and the learned model M is outputted.

When inference is performed, in learned model inference processing S400, the processing target image 33 photographed by the photographing device of the first image pickup system is inputted, inference is performed using the learned model M, and an output image (inference image) 34 having a higher contrast than that of the processing target image 33 photographed by the photographing device of the first image pickup system.

Thus, the learned model M is generated, with the own image picked up by the first image pickup system, which is the same image pickup system that picks up the processing target image 33, as the original image 10 of the data set for learning (correct answer image 11 and the training image 14), and thereby an output image having a higher contrast than that of the own image photographed by the high-resolution photographing device can be generated even if the performance of the high-resolution photographing device is improved.

### Third Embodiment

A third embodiment will now be described.

Thanks to the development of the AI technology in recent years, it is now possible to generate an image corresponding to a high-resolution image photographed by a high-resolution photographing device from a low-resolution image photographed by a low-resolution photographing device. In other words, a difference in performance between high-resolution photographing devices and low-resolution photographing devices has become small, which may result in a prediction of a decrease in distribution and degradation in performance of the high-resolution photographing devices. Such circumstances could lead to a situation in which images for learning that are photographed by a high-resolution photographing device cannot be prepared sufficiently.

Therefore, there is a need for creating an image for learning (data set for learning) having a higher contrast than that of the image photographed by the high-resolution photographing device from an image photographed by the low-resolution photographing device. In the third embodiment, description will be made on an example in which machine learning is performed using the low-resolution image photographed by the low-resolution photographing device as an original image of the correct answer image and a training image.

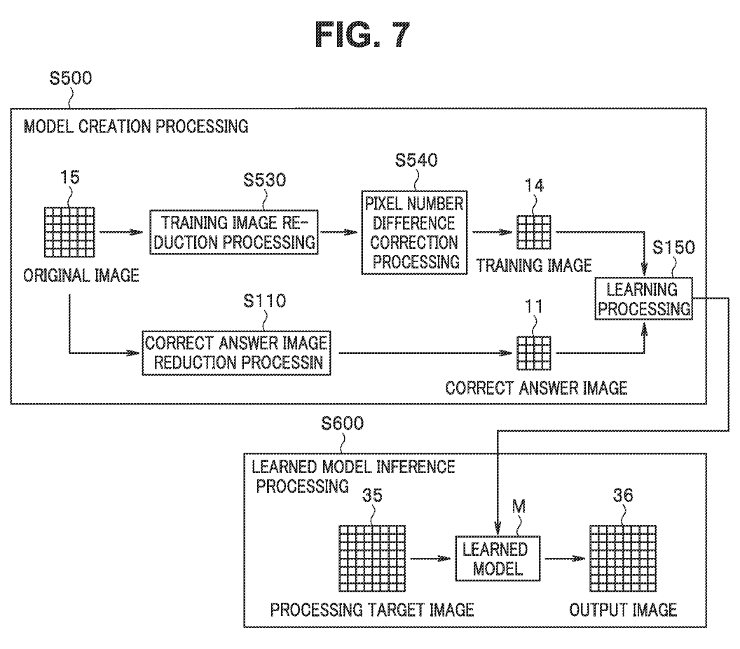

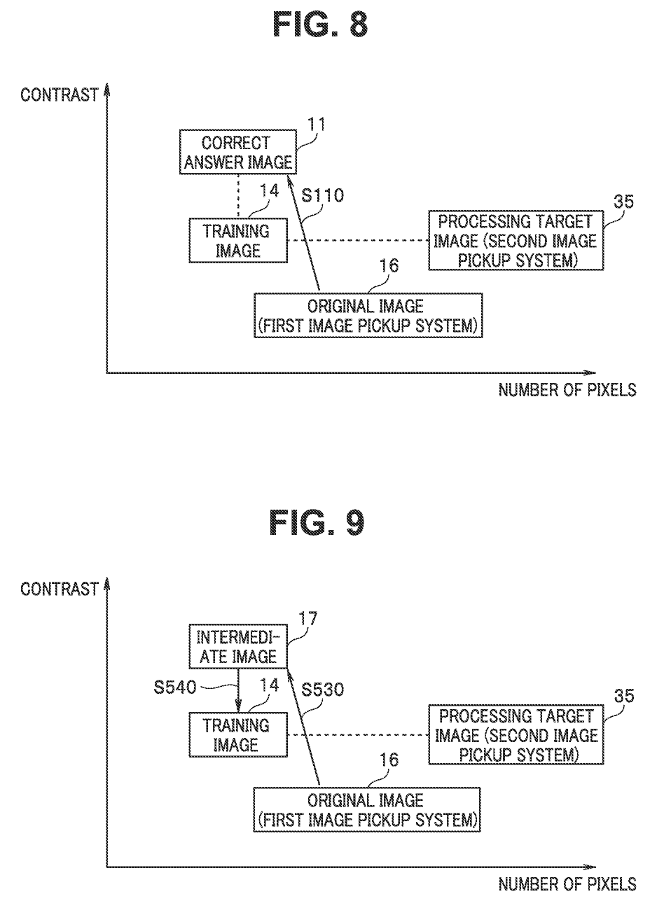

FIG. 7 shows one example of processing flows of model creation processing and learned model inference processing according to the third embodiment. FIG. 8 shows one example of a relationship between the original image and the correct answer image in the processing flow of the model creation processing in the third embodiment. FIG. 9 shows one example of a relationship between the original image and the training image in the processing flow of the model creation processing in the third embodiment. Note that, in FIGS. 7, 8, and 9, the same constituent elements as those in FIGS. 1, 2, and 3 are attached with the same reference signs and descriptions thereof will be omitted.

In model creation processing S500, an original image 16 photographed by the first image pickup system is inputted. In learned model inference processing S600, a processing target image 35 photographed by the second image pickup system is inputted.

The first image pickup system is a low-resolution image pickup system and the second image pickup system is an image pickup system with a higher resolution than the first image pickup system. In other words, in the present embodiment, the original image 16 is an image with a lower resolution than that of the processing target image 35 photographed by the second image pickup system with the high resolution.

In correct answer image reduction processing S110, processing for reducing the original image 16 is performed, and a correct answer image 11 is generated. With the correct answer image reduction processing S110, a spatial frequency per pixel is converted into the one on the high-frequency side, and the correct answer image 11 having a higher contrast than that of the original image 16 is generated. In other words, as shown in FIG. 8, with the correct answer image reduction processing S110, the correct answer image 11 having a smaller number of pixels and a higher contrast than those of the original image 10 is generated. Note that the number of pixels of the correct answer image 11 may be any number that makes the contrast of the correct image 11 greater than the contrast of the processing target image 35.

In training image reduction processing S530, processing for reducing the original image 16 is performed, and an intermediate image 17 (see FIG. 9) is generated. With the training image reduction processing S530, the spatial frequency per pixel is converted into the one on the high-frequency side, and thereby the intermediate image 17 having a smaller number of pixels than that of the processing target image 35 and a higher contrast than that of the processing target image 35 is generated.

In pixel number difference correction processing S540, correction processing is performed such that the contrast of the intermediate image 17, which has been increased higher than that of processing target image 35 by the training image reduction processing S530, becomes a contrast of the same level as that of the processing target image 35, and thereby the training image 14 is generated.

Specifically, in the pixel number difference correction processing S540, blur addition processing for adding a blur for correcting a contrast difference due to a difference in the number of pixels between the training image 14 and the processing target image 35. In other words, in the pixel number difference correction processing S540, the correction filter is applied, and processing for degrading the frequency characteristics, which have been increased by the training image reduction processing S530, to those corresponding to the frequency characteristics of the processing target image 35. As a result, as shown in FIG. 9, the training image 14 having the smaller number of pixels than that of the processing target image 35 and having the contrast of the same level as that of the processing target image 35 is generated.

Noise may be re-added for correcting the amount of noise decreased by the pixel number difference correction processing.

The image pickup system simulating processing, the reduction processing, the pixel number difference correction processing, and the noise re-addition processing may be performed independently in this order, but the order of performing each processing may be changed, and a plurality of processing may be performed simultaneously.

In learning processing S150, machine learning is performed by using the high-contrast correct answer image 11 generated by the correct answer image reduction processing S110 and the low-contrast training image 14 generated by the training image reduction processing S550 and the pixel number difference correction processing S540, and the learned model M is outputted.

When inference is performed, in the learned model inference processing S600, the processing target image 35 photographed by the photographing device of the second image pickup system is inputted, inference is performed using the learned model M, and an output image (inference image) 36 having a higher contrast than that of the processing target image 35 photographed by the photographing device of the second image pickup system is outputted.

Thus, in the present embodiment, the learned model M is generated, with the low-resolution image photographed by the low-resolution photographing device of the first image pickup system as the original image 16 of the correct answer image 11 and the training image 14. With such a configuration, even if the high-resolution image, which serves as the original image of the correct answer image 11 and the training image 14, is not available due to the decrease in the distribution and the degradation of the performance of the high-resolution photographing device, the output image 36 having the higher contrast than that of the processing target image 35 photographed by the high-resolution photographing device of the second image pickup system can be generated.

### Fourth Embodiment

A fourth embodiment will now be described.

In order to create an AI specialized for medical use, there is a need for causing the AI to learn images for learning that meet the objective of a photographing device for acquiring an inference target image. Although an enormous number of images for learning are required for pre-learning, if the image picked up by one image pickup system is used as the original image as described in the first to third embodiments, it is difficult to acquire the sufficient number of images for learning.

In view of the above, in the fourth embodiment, description will be made on model creation processing in which a learned model is created by using images picked up by a plurality of photographing devices, in other words, a plurality of image pickup systems, as original images.

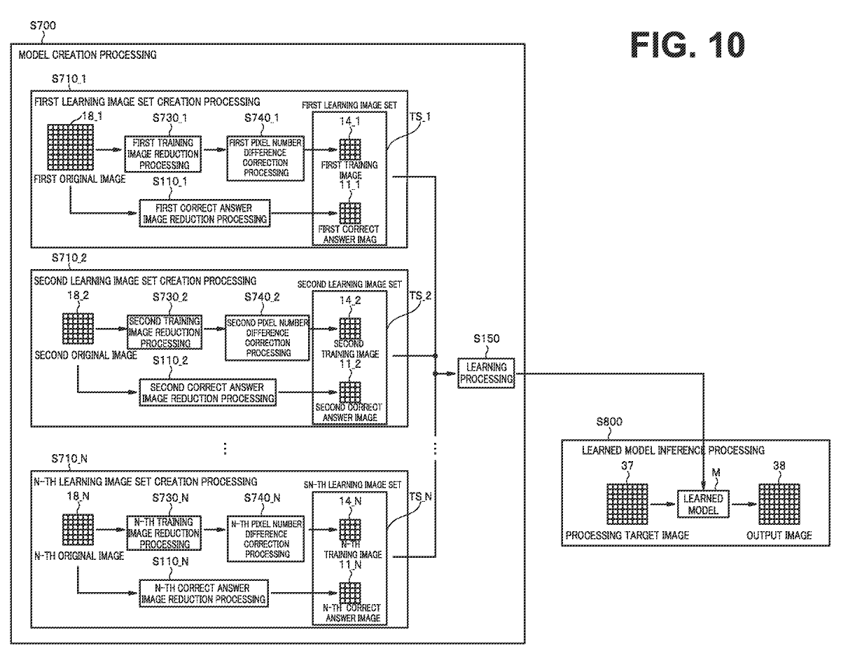

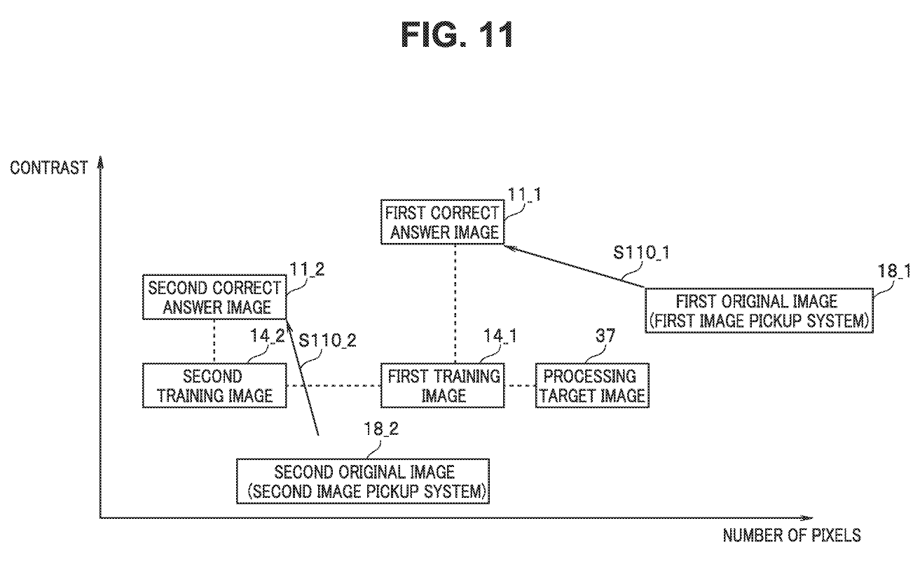

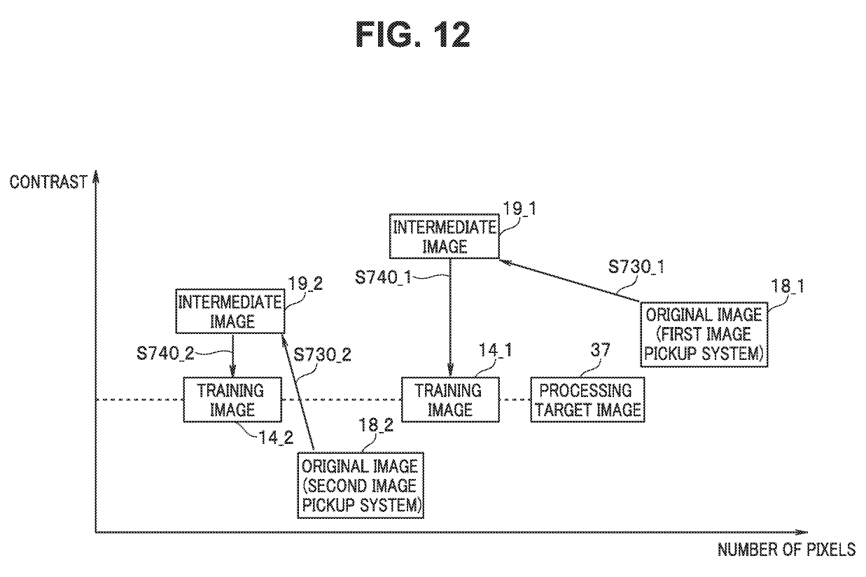

FIG. 10 shows one example of processing flows of the model creation processing and learned model inference processing according to the fourth embodiment. FIG. 11 shows one example of a relationship between original images and correct answer images in the processing flow of the model creation processing in the fourth embodiment. FIG. 12 shows one example of a relationship between the original images and training images in the processing flow of the model creation processing in the fourth embodiment. Note that, in FIGS. 10, 11, and 12, the same constituent elements as those in FIGS. 1, 2, and 3 are attached with the same reference signs and descriptions thereof will be omitted.

Model creation processing S700 includes first learning image set creation processing S710_1, second learning image set creation processing S710_2, ..., N-th learning image set creation processing S710_N, and learning processing S150.

In the first learning image set creation processing S710_1, the second learning image set creation processing S710_2, ..., and the N-th learning image set creation processing S710_N, a first original image 18_1, a second original image 18_2, ..., an N-th original image 18_N, which have been photographed respectively by different photographing devices, are respectively inputted. The first original image 18_1 is an image picked up by the first image pickup system, the second original image 18_2 is an image picked up by the second image pickup system, and the N-th original image 18_N is an image picked up by the N-th image pickup system. In addition, in learned model inference processing S800, for example, a processing target image 37 photographed by a third image pickup system is inputted.

For example, the first image pickup system is an image pickup system with a higher resolution than the third image pickup system, and the second image pickup system is an image pickup system with a lower resolution than the third image pickup system. Therefore, as shown in FIG. 11, the first original image 18_1 is a high-resolution image having a larger number of pixels and a higher contrast than those of the processing target image 37, and the second original image 18_2 is a low-resolution image having a smaller number of pixels and a lower contrast than those of the processing target image 37.

In the first learning image set creation processing S710_1, first correct answer image reduction processing S110_1 for reducing the number of pixels is performed on the first original image 18_1. With the first correct answer image reduction processing S110_1, as shown in FIG. 11, a first correct answer image 11_1 having a smaller number of pixels and a higher contrast than those of the processing target image 37 is generated.

In addition, in the first learning image set creation processing S710_1, first training image reduction processing S730_1 for reducing the number of pixels is performed on the first original image 18_1. With the first training image reduction processing S730_1, as shown in FIG. 12, an intermediate image 19_1 having a smaller number of pixels and a higher contrast than those of the processing target image 37 is generated.

In first pixel number difference correction processing S740_1, correction processing is performed such that the contrast of the intermediate image 19_1, which has been increased higher than that of the processing target image 37 by the first training image reduction processing S730_1, becomes a contrast of the same level as that of the processing target image 37, and thereby a first training image 14_1 is generated.

Specifically, in the first pixel number difference correction processing S740_1, blur addition processing for adding a blur for correcting a contrast difference due to a difference in the number of pixels between the first training image 14_1 and the processing target image 37. In other words, in the first pixel number difference correction processing S740_1, a correction filter is applied, and processing for degrading the frequency characteristics, which have been increased by the first training image reduction processing S730_1, to those corresponding to the frequency characteristics of the processing target image 37. As a result, as shown in FIG. 12, the first training image 14_1 having the smaller number of pixels than that of the processing target image 37 and a contrast of the same level as that of the processing target image 37 is generated.

Noise may be re-added for correcting the amount of noise decreased by the pixel number difference correction processing.

The image pickup system simulating processing, the reduction processing, the pixel number difference correction processing, and the noise re-addition processing may be performed independently in this order, but the order of performing each processing may be changed, and a plurality of processing may be performed simultaneously.

A pair of the first correct answer image 11_1 and the first training image 14_1 thus generated is inputted, as a first learning image set TS_1, to be used in the learning processing S150.

Similarly, a second learning image set TS_2, ..., and an N-th learning image set TS_N are generated respectively in the second learning image set creation processing S710_2, ..., and the N-th learning image set creation processing S710_N, and inputted to be used in the learning processing S150.

In the learning processing S150, machine learning is performed by using a plurality of learning image sets including the first learning image set TS_1, the second learning image set TS_2, ..., and the N-th learning image set TS_N, and the learned model M is generated.

When inference is performed, in the learned model inference processing S800, the processing target image 37 photographed by a photographing device of the third image pickup system is inputted, inference is performed using the learned model M, and an output image (inference image) 38 having a higher contrast than that of the processing target image 37 photographed by the photographing device of the third image pickup system is outputted.

Since the images for learning are generated as described above, even in the case where the sufficient number of images for learning that meet the objective of the photographing device for acquiring the inference target images cannot be prepared, the images photographed by the plurality of image pickup systems can be diverted to the images for learning as original images, which enables the sufficient number of images for learning to be prepared.

### Fifth Embodiment

A fifth embodiment will now be described.

As an image pickup device that picks up an image of an object to be photographed, various types of image pickup devices, such as a monochrome type, a Bayer type, or a complementary color type can be employed. For example, an image picked up by a complementary color type image pickup device varies in the number of pixels during a process of image processing, which results in a change in the effect of AI processing changes depending on the location of the image processing where the AI processing is performed. In view of the above, even in the case where a ratio of the vertical (vertical direction) to the horizontal (horizontal direction) of the image is not as expected, the AI processing using a model caused to learn in accordance with the unexpected ratio is required to be applied.

Therefore, in the fifth embodiment, description will be made on an example in which machine learning is performed by creating an image for learning obtained by performing pixel conversion processing applying different ratios to the vertical (vertical direction) direction and the horizontal (horizontal direction) of the image.

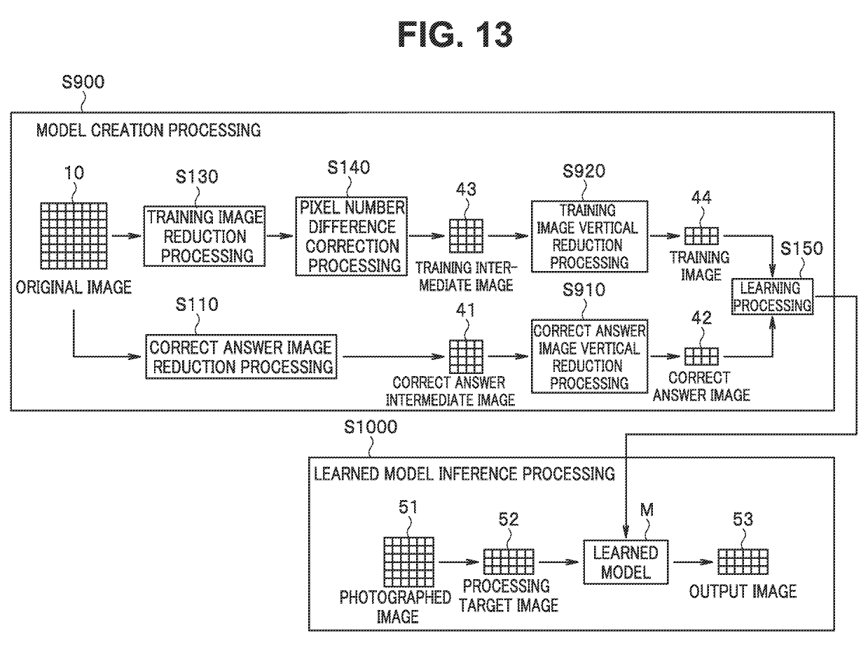

FIG. 13 shows one example of processing flows of model creation processing and learned model inference processing according to the fifth embodiment. Note that, in FIG. 13, the same constituent elements as those in FIG. 1 are attached with the same reference signs and descriptions thereof will be omitted.

In model creation processing S900, an original image 10 is inputted. As the original image 10, an image picked up by any of the various types of image pickup devices including the monochrome type, the Bayer type, or the complementary color type can be used. Correct answer image reduction processing S110 is performed on the original image 10, and thereby a correct answer intermediate image 41 is generated.

In correct answer image vertical reduction processing S910 (third reduction processing), reduction processing is performed on the correct answer intermediate image 41, and thereby a correct answer image 42 having an aspect ratio different from that of the correct answer intermediate image 41 is generated. Specifically, by interpolating or thinning out the vertical (vertical direction) pixels of the correct answer intermediate image 41, the number of the vertical (vertical direction) pixels of the correct answer intermediate image 41 is reduced to half the number of the horizontal (horizontal direction) pixels of the correct answer intermediate image 41.

In addition, training image reduction processing S130 and pixel number difference correction processing S140 are performed on the original image 10, and thereby a training intermediate image 43 is generated.

Noise may be re-added for correcting the amount of noise decreased by the pixel number difference correction processing.

The reduction processing, the pixel number difference correction processing, and the noise re-addition processing may be performed independently in this order, but the order of performing each processing may be changed, and a plurality of processing may be performed simultaneously.

In training image vertical reduction processing S920 (fourth reduction processing), reduction processing is performed on the training intermediate image 43, and thereby a training image 44 having an aspect ratio different from that of the training intermediate image 43 is generated. Specifically, by interpolating or thinning out the vertical (vertical direction) pixels of the training intermediate image 43, the number of the vertical (vertical direction) pixels of the training intermediate image 43 is reduced to half the number of the horizontal (horizontal direction) pixels of the training intermediate image 43.

In learning processing S150, machine learning is performed by using the correct answer image 42 generated by the correct answer image vertical reduction processing S910 and the training image 44 generated by the training image vertical reduction processing S920, and the learned model M is outputted.

When inference is performed, in learned model inference processing S1000, an odd number field or an even number field of a photographed image 51 photographed by a complementary color type photographing device are inputted as a processing target image 52, and inference is performed using the learned model M, and an output image (inference image) 53 is outputted. With such processing, the output image 53 having the uniform characteristics in the vertical and horizontal directions can be outputted.

### Sixth Embodiment

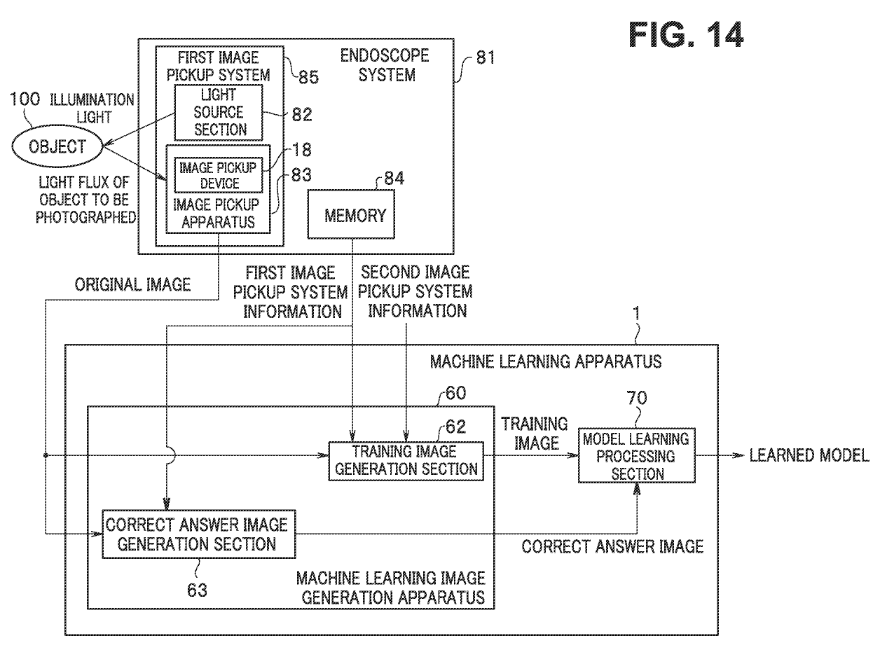

FIG. 14 is a block diagram of a machine learning apparatus 1 as an information processing apparatus, which acquires an original image from an endoscope system 81. The machine learning apparatus 1 includes a machine learning image generation apparatus 60 and a model learning processing section (model learning processing unit) 70. The machine learning image generation apparatus 60 includes a training image generation section (training image generation unit) 62, and a correct answer image generation section (correct answer image generation unit) 63.

The endoscope system 81 includes a memory 84, and a first image pickup system 85 (a light source section 82 and image pickup apparatus 83). The light source section 82 applies illumination light to an object 100 which is a predetermined object to be photographed. A light flux of the object to be photographed, which is return light from the object 100, is incident on the image pickup apparatus 83.

The image pickup apparatus 83 forms an image of the light flux of the object to be photographed, picks up the image by the image pickup device 18, and outputs an original image. The original image is inputted into the training image generation section 62 and the correct answer image generation section 63.

The memory 84 is a storage medium that stores information on the endoscope system 81 in a non-volatile manner. The information stored in the memory 84 includes first image pickup system information. The first image pickup system information is information related to the image pickup apparatus 83 that acquires the original image. Second image pickup system information is stored in a memory (not shown) or the like of the machine learning apparatus 1.

The first image pickup system information includes: information on the number of pixels of the image pickup device; information on a color of the image acquired by the image pickup apparatus 83; optical characteristic information including a PSF of the image pickup optical system; noise characteristic information related to the image pickup device and a reading circuit and the like that reads out information from the image pickup device; color filter information indicating whether the image pickup device acquires which of a Bayer image, a surface-sequential image, or a complementary color image; and other information.

The light source section 82 is configured to be capable of emitting, for example, illumination light corresponding to each of a plurality of kinds of observation modes. The observation modes include, for example, a white light observation (WLI: White Light Imaging) mode, a narrow-band light observation (NBI: Narrow Band Imaging) mode, and the like. Original image light source information is information indicating the kind of illumination light (WLI illumination light, NBI illumination light, etc.) emitted from the light source section 82 according to each of the observation modes.

The endoscope system 81 transmits the first image pickup system information from the memory 84 to the machine learning apparatus 1.

The training image generation section 62 of the machine learning apparatus 1 receives the first image pickup system information from the endoscope system 81, and receives the second image pickup system information from the machine learning image generation apparatus 60. The correct answer image generation section 63 receives the first image pickup system information from the endoscope system 81.

Based on the original image light source information, the training image generation section 62 changes the reduction ratio of the number of pixels and the correction filter according to the kind of the illumination light (WLI illumination light, NBI illumination light, etc.). At this time, the training image generation section 62 may further change the reduction ratio of the number of pixels and the correction filter, based on the optical characteristic information and the noise characteristic information included in the first image pickup system information and the second image pickup system information.

Similarly, the correct answer image generation section 63 changes, based on the original image light source information, the reduction ratio of the number of pixels, for example, according to the kind of the illumination light (WLI illumination light, NBI illumination light, etc.). At this time, the correct answer image generation section 63 may further change the reduction ratio of the number of pixels based on the optical characteristic information included in the first image pickup system information and the second image pickup system information.

Furthermore, the training image generation section 62 and the correct answer image generation section 63 may change, for example, color correction processing, as needed, based on the information on the color included in the first image pickup system information.

The training image generation section 62 and the correct answer image generation section 63 may change, as needed, for example, conversion processing from the Bayer image to the surface-sequential image or from the surface-sequential image to the Bayer image, based on the color filter information included in the first image pickup system information.

### Seventh Embodiment

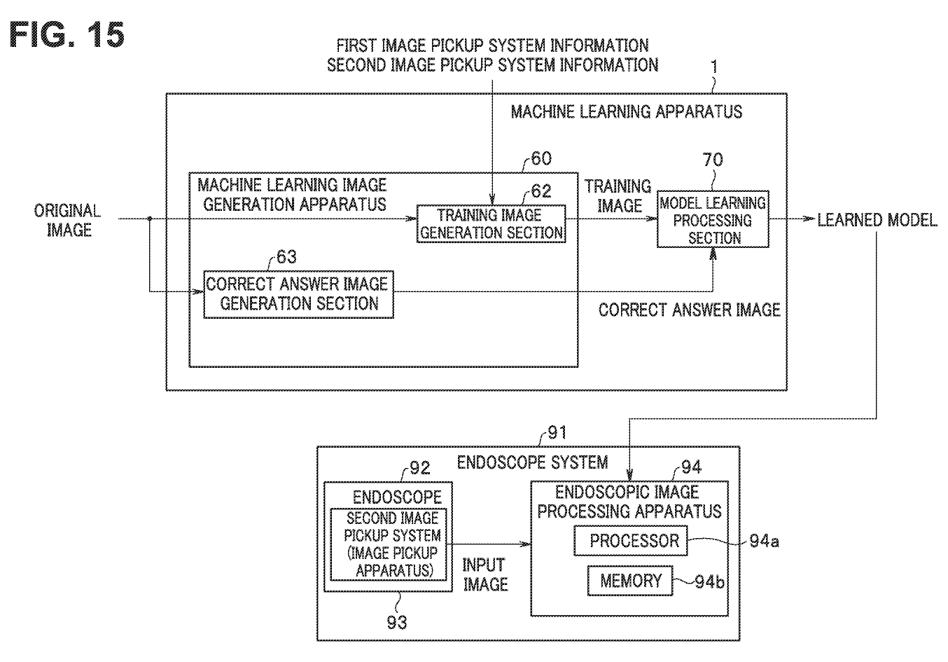

FIG. 15 is a block diagram showing a configuration example in which the learned model M caused to learn by the machine learning apparatus 1, which is the information processing apparatus, is applied to an endoscope system 91.

The endoscope system 91 includes an endoscope 92, and an endoscopic image processing apparatus 94. An image pickup apparatus 93 is the second image pickup system that forms an image of a light flux of an object to be photographed, picks up the image by the image pickup device, and outputs an endoscopic image. The endoscopic image outputted from the image pickup apparatus 93 becomes an input image to be inputted into the endoscopic image processing apparatus 94.

The endoscopic image processing apparatus 94 includes a processor 94a, and a memory 94b, for example. The processor 94a is configured by an ASIC (Application Specific Integrated Circuit), an FPGA (Field Programmable Gate Array), or the like, including a CPU (Central Processing Unit), etc. However, the endoscopic image processing apparatus 94 may be configured as a dedicated electronic circuit configured to execute the functions of the learned model M.

The memory 94b is a storage medium that saves (stores in the non-volatile manner) a processing program that implements functions of respective circuits. The processor 94a is connected to a wiring drawn out from the memory 94b. The processor 94a reads and executes the processing program stored in the memory 94b, to thereby implement the functions of the endoscopic image processing apparatus 94. For example, the endoscopic image processing apparatus 94 implements an endoscopic image processing method by executing the processing program.

A combination of the learned model M, i.e., the AI program (algorithm), generated by the machine learning apparatus 1 and the parameters optimized by learning is stored in the memory 94b of the endoscopic image processing apparatus 94. The memory 94b and the wiring drawn out from the memory 94b constitute a machine learning model connecting section which is connectable to the learned model M.

The processor 94a executes the endoscopic image processing method, to perform inference on the processing target image (photographed image) which is the input image, by using the learned model M, and uses the image after the inference as the output image. As a result that the inference is performed appropriately, the image after the inference becomes an endoscopic image whose resolution has been improved more than that of the input image.

The present disclosure is not limited to the embodiments described above, and can be subjected to various changes, modifications and the like in a range without changing the gist of the present disclosure. For example, the present disclosure can be applied to AI processing to be performed on images for detecting an object with poor visibility (for example, in a case where a pedestrian with poor visibility is detected by a vehicle-mounted camera).

What is claimed is:

1. A learned model caused to learn by machine learning by using:
a correct answer image obtained by performing first reduction processing for image reduction on an original image obtained by photographing a predetermined object to be photographed by a first image pickup system; and
a training image obtained by performing second reduction processing for image reduction on the original image and performing, on an image as a result of the second reduction processing, blur addition processing for correcting a contrast difference due to a difference in a number of pixels between the image as the result of the second reduction processing and a processing target image photographed by a second image pickup system.

2. The learned model according to claim 1, wherein
the second reduction processing for image reduction is performed on a first intermediate image obtained by further performing image pickup system simulating processing on the original image, and
the first image pickup system that photographs the original image has a resolution higher than a resolution of the second image pickup system that photographs the processing target image.

3. The learned model according to claim 1, wherein
the first image pickup system that photographs the original image is a same image pickup system as the second image pickup system that photographs the processing target image.

4. The learned model according to claim 1, wherein
the first image pickup system that photographs the original image has a resolution lower than a resolution of the second image pickup system that photographs the processing target image.

5. A learned model caused to learn by machine learning by using:
a first correct answer image obtained by performing first reduction processing for image reduction on a first original image obtained by photographing a predetermined object to be photographed by a first image pickup system;
a first training image obtained by performing second reduction processing for image reduction on the first original image or on a first intermediate image obtained by performing image pickup system simulating processing on the first original image and performing, on an image as a result of the second reduction processing, blur addition processing for correcting a contrast difference due to a difference in a number of pixels between the image as the result of the second reduction processing and a processing target image photographed by a third image pickup system;
a first learning set including a pair of the first correct answer image and the first training image;
a second correct answer image obtained by performing third reduction processing for image reduction on a second original image obtained by photographing the predetermined object to be photographed by a second image pickup system;
a second training image obtained by performing fourth reduction processing for image reduction on the second original image or on a second intermediate image obtained by performing the image pickup system simulating processing on the second original image and performing, on an image as a result of the fourth reduction processing, blur addition processing for correcting a contrast difference due to a difference in a number of pixels between the image as the result of the fourth reduction processing and the processing target image photographed by the third image pickup system;
a second learning set including a pair of the second correct answer image and the second training image; and
a plurality of learning sets including the first learning set and the second learning set.

6. A learned model caused to learn by machine learning by using:
a correct answer image obtained by performing first reduction processing for image reduction on an original image obtained by photographing a predetermined object to be photographed by a first image pickup system and performing, on an image as a result of the first reduction processing, second reduction processing for generating an image having an aspect ratio different from an aspect ratio of the image as the result of the first reduction processing; and
a training image obtained by performing third reduction processing for image reduction on the original image, performing, on an image as a result of the third reduction processing, blur addition processing for correcting a contrast difference due to a difference in a number of pixels between the image as the result of the third reduction processing and a processing target image photographed by a second image pickup system, and performing, on an image as a result of the blur addition processing, fourth reduction processing for generating an image having an aspect ratio different from an aspect ratio of the image as the result of the blur addition processing.

7. An information processing apparatus comprising:
a correct answer image generation unit configured to generate a correct answer image by performing first reduction processing for image reduction on an original image obtained by photographing a predetermined object to be photographed by a first image pickup system; and
a training image generation unit configured to generate a training image by performing second reduction processing for image reduction on the original image and performing, on an image as a result of the second reduction processing, blur addition processing for correcting a contrast difference due to a difference in a number of pixels between the image as the result of the second reduction processing and a processing target image photographed by a second image pickup system.
